(19) United States
(12) Patent Application Publication
(10) Pub. No.: US 2026/0133751 A1
(43) Pub. Date: May 14, 2026

(54) MEDIA CONTENT DISPLAY METHOD AND APPARATUS, DEVICE, AND STORAGE MEDIUM

(71) Applicant: Beijing Zitiao Network Technology Co., Ltd., Beijing (CN)

(72) Inventor: Anjiang ZHAO, Beijing (CN)

(21) Appl. No.: 19/119,675

(22) PCT Filed: Sep. 22, 2023
(86) PCT No.: PCT/CN2023/120705

§ 371 Date: Apr. 9, 2025

(30) Foreign Application Priority Data
Oct. 9, 2022 (CN) 202211230048.2

(51) Int. Cl. G06F 3/16; G06F 3/0484

(52) U.S. Cl. CPC G06F 3/165; G06F 3/0484

(57) ABSTRACT

A media content display method and apparatus, a device, and a storage medium. The method includes: in response to a play trigger operation for a target media content set, playing a piece of target music in the target media content set, and displaying a first picture in a picture sequence in the target media content set; obtaining a current time point of the target music in response to determining that display of the first picture ends; determining, from a synchronization time sequence corresponding to the target music, a synchronization time corresponding to the current time point as a target synchronization time; and displaying, based on the current time point of the target music and the target synchronization time, a second picture during playing the target music.

This application claims priority to Chinese Patent Application No. 202211230048.2, filed on Oct. 9, 2022, which is incorporated herein by reference in its entirety as a part of this application.

### TECHNICAL FIELD

Embodiments of the present disclosure relate to a media content display method, apparatus, and device, and a storage medium.

### BACKGROUND

With continuous development of multimedia technologies, a growing number of users record their work and life by releasing media content.

However, current manners of displaying media content (for example, picture and text works) are relatively few, and cannot meet use requirements of users. Therefore, display manners of the media content need to be enriched to improve display effect.

### SUMMARY

In order to solve the above technical problems, the embodiment of the present disclosure provides a media content display method.

In a first aspect, the present disclosure provides a media content display method, including:
in response to a play trigger operation for a target media content set, playing a piece of target music in the target media content set, and displaying a first picture in a picture sequence in the target media content set, where the picture sequence includes a plurality of pictures with a preset play order;
obtaining a current play time point of the target music in response to determining that display of the first picture ends;
determining, from a synchronization time sequence corresponding to the target music, a synchronization time corresponding to the current play time point as a target synchronization time; and
controlling, based on the current play time point of the target music and the target synchronization time, a second picture to be displayed during playing the target music, where the second picture is a next picture adjacent to the first picture in the picture sequence.

In an optional embodiment, the obtaining a current play time point of the target music in response to determining that display of the first picture ends includes:
obtaining the current play time point of the target music in response to receiving a preset picture switching operation for the first picture.

In an optional embodiment, the determining, from a synchronization time sequence corresponding to the target music, a synchronization time corresponding to the current play time point as a target synchronization time includes:
matching the current play time point with the synchronization time sequence corresponding to the target music; and
determining, based on a result of matching between the current play time point and the synchronization time sequence, the synchronization time corresponding to the current play time point as the target synchronization time.

In an optional embodiment, the matching the current play time point with the synchronization time sequence corresponding to the target music includes:
determining whether the current play time point is in a time interval corresponding to any synchronization time in the synchronization time sequence corresponding to the target music, where the time interval is determined based on the synchronization time and a preset fluctuation value; and
correspondingly, the determining, based on a result of matching between the current play time point and the synchronization time sequence, the synchronization time corresponding to the current play time point as the target synchronization time includes:
in response to determining that the current play time point is in the time interval corresponding to any synchronization time in the synchronization time sequence, determining a next synchronization time adjacent to the synchronization time in the synchronization time sequence as the synchronization time corresponding to the current play time point and as the target synchronization time; and/or
in response to determining that the current play time point is not in the time interval corresponding to any synchronization time in the synchronization time sequence, determining a next synchronization time closest to the current play time point in the synchronization time sequence as the synchronization time corresponding to the current play time point and as the target synchronization time.

In an optional embodiment, the controlling, based on the current play time point of the target music and the target synchronization time, a second picture to be displayed during playing the target music includes:
controlling the second picture to start to be displayed at the current play time point of the target music, and controlling the second picture to end being displayed when the target music is played to the target synchronization time.

In an optional embodiment, the controlling, based on the current play time point of the target music and the target synchronization time, a second picture to be displayed during playing the target music includes:
determining play duration of the second picture based on the current play time point of the target music and the target synchronization time; and
controlling the second picture to start to be displayed at the current play time point of the target music, and starting timing, and controlling the second picture to end being displayed when timing duration reaches the play duration.

In an optional embodiment, the first picture is a last picture in the picture sequence, and the second picture is a starting picture in the picture sequence.

In an optional embodiment, the in response to a play trigger operation for a target media content set, playing a piece of target music in the target media content set, and displaying a first picture in a picture sequence in the target media content set includes:
in response to the play trigger operation for the target media content set, playing the target music in the target media content set, and detecting whether the synchronization time sequence corresponding to the target music exists in the target media content set; and
in response to not detecting the synchronization time sequence corresponding to the target music, displaying the first picture in the picture sequence in the target media content set based on default play duration; and
correspondingly, the obtaining a current play time point of the target music in response to determining that display of the first picture ends includes:
in response to determining that display of the first picture ends, when the synchronization time sequence corresponding to the target music is detected, obtaining the current play time point of the target music.

In an optional embodiment, before the determining, from a synchronization time sequence corresponding to the target music, a synchronization time corresponding to the current play time point as a target synchronization time, the method further includes:
processing abnormal synchronization times in the synchronization time sequence corresponding to the target music, where the abnormal synchronization times includes adjacent synchronization times with interval duration greater than a preset first duration threshold and/or adjacent synchronization times with interval duration less than a preset second duration threshold.

In an optional embodiment, the synchronization time sequence includes a synchronization time determined based on a rhythm change feature and/or a lyric feature of the target music.

In a second aspect, the present disclosure provides a media content display apparatus, including:
a display module, configured to: in response to a play trigger operation for a target media content set, play a piece of target music in the target media content set, and display a first picture in a picture sequence in the target media content set, where the picture sequence includes a plurality of pictures with a preset play order;
an obtaining module, configured to obtain a current play time point of the target music in response to determining that display of the first picture ends;
a determining module, configured to determine, from a synchronization time sequence corresponding to the target music, a synchronization time corresponding to the current play time point as a target synchronization time; and
a control module, configured to control, based on the current play time point of the target music and the target synchronization time, a second picture to be displayed during playing the target music, where the second picture is a next picture adjacent to the first picture in the picture sequence.

In a third aspect, the present disclosure provides a computer-readable storage medium storing instructions, where when the instructions are run on a terminal device, the terminal device is enabled to implement the foregoing method.

In a fourth aspect, the present disclosure provides a media content display device, including a memory, a processor, and a computer program that is stored in the memory and that can be run on the processor, where when the processor executes the computer program, the foregoing method is implemented.

In a fifth aspect, the present disclosure provides a computer program product, including a computer program/instruction, where when the computer program/instruction is executed by a processor, the foregoing method is implemented.

### BRIEF DESCRIPTION OF DRAWINGS

The accompanying drawings herein are incorporated into this specification and constitute a part of this specification, illustrating embodiments that comply with the present disclosure, and used together with the specification to explain principles of the present disclosure.

To describe embodiments of the present disclosure more clearly, the following briefly describes the accompanying drawings that need to be used in embodiments. Apparently, those of ordinary skill in the art may still derive other drawings from these accompanying drawings without creative efforts.

FIG. 1 is a flowchart of a media content display method according to an embodiment of the present disclosure;

FIG. 2 is a schematic diagram of a synchronization time of target music according to an embodiment of the present disclosure;

FIG. 3 is a schematic diagram of a picture display page according to an embodiment of the present disclosure;

FIG. 4 is a schematic diagram of another picture display page according to an embodiment of the present disclosure;

FIG. 5 is a flowchart of another media content display method according to an embodiment of the present disclosure;

FIG. 6 is a schematic diagram of another synchronization time of target music according to an embodiment of the present disclosure;

FIG. 7 is a schematic diagram of still another synchronization time of target music according to an embodiment of the present disclosure;

FIG. 8 is a schematic structural diagram of a media content display apparatus according to an embodiment of the present disclosure; and

FIG. 9 is a schematic structural diagram of a media content display device according to an embodiment of the present disclosure.

### DETAILED DESCRIPTION

In order to understand the foregoing objectives, features, and advantages of the present disclosure more clearly, the following further describes the solutions of the present disclosure. It should be noted that, if there is no conflict, embodiments and features in the embodiments of the present disclosure may be combined with each other.

Many specific details are described in the following descriptions to fully understand the present disclosure, but the present disclosure may also be implemented in another manner different from the manner described herein. Apparently, the embodiments in this specification are merely some embodiments of the present disclosure, but not all the embodiments.

In current media applications, a beat synchronization point of each picture in a beat synchronization media work has a correspondence with a fixed time point of music, and different beat effects cannot be generated through a control operation on beat synchronization media content by a user browsing the work in a play process, and when the user performs, for example, a picture switching operation, music jumps. Therefore, to enrich display forms of picture and text works and improve display effect, an embodiment of the present disclosure provides a media content display method.

Specifically, first, in response to a play trigger operation for a target media content set, a piece of target music in the target media content set is played, and a first picture in a picture sequence in the target media content set is displayed, where the picture sequence includes a plurality of pictures with a preset play order. A current play time point of the target music is obtained in response to determining that display of the first picture ends. A synchronization time corresponding to the current play time point is determined from a synchronization time sequence corresponding to the target music as a target synchronization time. And a second picture is controlled, based on the current play time point of the target music and the target synchronization time, to be displayed during playing the target music, where the second picture is a next picture adjacent to the first picture in the picture sequence. In view of this, in this embodiment of the present disclosure, based on the synchronization time sequence corresponding to the target music, pictures are played based on beat synchronization points, so that display forms of media content are enriched, thereby improving display effect.

Based on this, an embodiment of the present disclosure provides a media content display method. FIG. 1 is a flowchart of a media content display method according to an embodiment of the present disclosure. The method includes:
S101: in response to a play trigger operation for a target media content set, playing a piece of target music in the target media content set, and displaying a first picture in a picture sequence in the target media content set.

The picture sequence includes a plurality of pictures with a preset play order. Specifically, the plurality of pictures with the preset play order are a picture set with a preset play order. The preset play order is used to identify a play order of the pictures in the picture sequence. The first picture may be any picture in the picture sequence.

The media content display method provided in this embodiment of the present disclosure may be applied to a client. For example, the client may include a client deployed on a smartphone, a client displayed on a tablet computer, or the like.

In this embodiment of the present disclosure, the target media content set may be any media content set. The target media content set may include media content such as target music and a picture sequence. The target music may be background music played in a picture sequence display process, or the like.

A correspondence between the target music and the picture sequence is preset, that is, the target music and the picture sequence belong to a same media content set. In the process of the playing the target music, the pictures in the picture sequence are sequentially displayed based on the preset play order of the picture sequence.

In this embodiment of the present disclosure, when the play trigger operation for the target media content set is received, the target music in the target media content set is played, and the first picture in the picture sequence in the target media content set is displayed. Specifically, the display manner of the first picture is not limited in this embodiment of the present disclosure.
S102: obtaining a current play time point of the target music in response to determining that display of the first picture ends.

In this embodiment of the present disclosure, during playing the target music, in response to determining that display of the first picture ends, the current play time point of the target music when display of the first picture ends is obtained as a start time for displaying the next picture adjacent to the first picture in the picture sequence.

In this embodiment of the present disclosure, picture switching display effect is achieved in a manner of calculating, in real time, display duration (or the play end time) of the next picture when display of the previous picture ends.
S103: determining, from a synchronization time sequence corresponding to the target music, a synchronization time corresponding to the current play time point as a target synchronization time.

The synchronization time sequence includes a synchronization time determined based on a rhythm change feature and/or a lyric feature of the target music.

In this embodiment of the present disclosure, the synchronization time may be obtained through analysis and extraction on the rhythm change feature and/or the lyric feature of the target music by a server based on a preset algorithm. For example, a play time point corresponding to a stress-timed rhythm in the target music may be determined as the synchronization time of the target music based on the rhythm change feature of the target music, or the play time point corresponding to a specific lyric in the target music may be determined as the synchronization time of the target music based on the lyric feature of the target music. In addition, the synchronization time sequence corresponding to the target music may further include synchronization times determined respectively based on the rhythm change feature and the lyric feature of the target music.

To facilitate controlling, by the client, switching display of pictures in the picture sequence based on a target music play progress, synchronization times in the synchronization time sequence may be arranged in a time increasing manner.

For example, the synchronization time sequence may be an array including synchronization times determined based on a rhythm change feature and/or a lyric feature of the target music, as shown in the follows:
[1.2, 3.4, 5.6, 6.7, 8.2, 9.1, 12.4]//synchronization time sequence

The foregoing synchronization time sequence indicates that the target music has a rhythm change feature and/or a lyric feature at locations such as the 1.2^{nd} second, the 3.4^{th} second, and 5.6^{th} second. Picture switching display is performed when the target music is played to the corresponding location, to achieve the effect of switching pictures at beat synchronization points.

In an optional implementation, after the current play time point of the target music is obtained, the current play time point is matched with the synchronization time sequence corresponding to the target music. Based on a result of matching between the current play time point and the synchronization time sequence, the synchronization time corresponding to the current play time point is determined, as the target synchronization time.

In this embodiment of the present disclosure, in response to determining that display of the first picture ends and obtaining the current play time point of the target music, the current play time point is matched with the synchronization time sequence corresponding to the target music. Optionally, a next synchronization time closest to the current play time point is determined from the synchronization time sequence corresponding to the target music as the target synchronization time.

Still with reference to the foregoing array, if it is determined that the current play time point of the target music obtained when display of the first picture ends is the 1.4^{th} second, the next synchronization time closest to the 1.4^{th} second is the 3.4^{th} second. In this case, the 3.4^{th} second is used as the target synchronization time, namely, the play end time of the next picture adjacent to the first picture.

To alleviate impact of an excessively long or short interval between adjacent synchronization times in the synchronization time sequence on the display effect, abnormal synchronization times in the synchronization time sequence corresponding to the target music may be preprocessed. Specifically, the abnormal synchronization times may include adjacent synchronization times with interval duration greater than a preset first duration threshold and/or adjacent synchronization times with interval duration less than a preset second duration threshold.

In this embodiment of the present disclosure, if the interval duration between the adjacent synchronization times in the synchronization time sequence corresponding to the target music is greater than the preset first duration threshold, it is possible that display duration of a particular picture is excessively long in the process of playing the target music. For this case, in this embodiment of the present disclosure, a new synchronization time may be added between the adjacent synchronization times, to prevent the excessively long display time of a particular picture from affecting the display effect in the process of playing the target music. If the interval duration between the adjacent synchronization times in the synchronization time sequence corresponding to the target music is less than the preset second duration threshold, it is possible that display duration of a particular picture is excessively short in the process of playing the target music. For this case, in this embodiment of the present disclosure, any synchronization time may be deleted from the adjacent synchronization times with the interval duration less than the preset second duration threshold, to prevent the excessively short display duration of a particular picture from affecting the display effect in the process of playing the target music.

The preset first duration threshold and the preset second duration threshold may be set based on requirements. This is not limited herein in the present disclosure.
S104: controlling, based on the current play time point of the target music and the target synchronization time, a second picture to be displayed during playing the target music.

The second picture is a next picture adjacent to the first picture in the picture sequence.

In an optional implementation, the second picture is controlled to start to be displayed at the current play time point of the target music, and is controlled to end being displayed when the target music is played to the target synchronization time.

Specifically, at the current play time point of the target music, the second picture is controlled to start to be displayed. During displaying the second picture, the play time of the target music is determined in real time, and in response to determining that the target music is played to the target synchronization time, the second picture is controlled to end being displayed.

In another optional implementation, play duration of the second picture is determined based on the current play time point of the target music and the target synchronization time. The second picture is controlled to start to be displayed at the current play time point of the target music, and timing is started, and the second picture is controlled to end being displayed when timing duration reaches the play duration.

In this embodiment of the present disclosure, the play duration of the second picture is equal to a difference obtained by subtracting the current play time point of the target music from the target synchronization time of the target music.

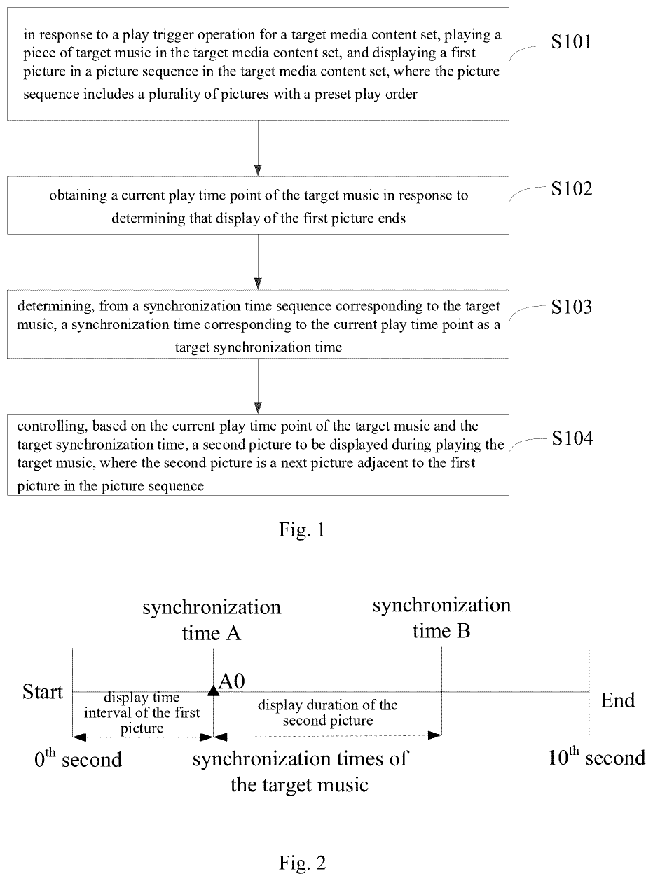

To understand the present disclosure more clearly, FIG. 2 is a schematic diagram of a synchronization time of target music according to an embodiment of the present disclosure. FIG. 2 displays start and end times of the target music and corresponding synchronization times. Assuming that display of the first picture ends at A0, when detecting that display of the first picture ends, the current play time point AO of the target music is obtained, and then a synchronization time B corresponding to the current play time point A0 is determined from the synchronization time sequence corresponding to the target music as the target synchronization time, so that the second picture is displayed in a time interval of A0-B.

In addition, the media content display method provided in this embodiment of the present disclosure further includes loop play of pictures. In an optional implementation, if the first picture is the last picture in the picture sequence, the second picture is the starting picture in the picture sequence. After display of the first picture ends, the starting picture in the picture sequence may also be controlled, based on the current play time point of the target music obtained when display of the first picture ends and the target synchronization time corresponding to the current play time point, to continue to be displayed in the process of playing the target music, so as to achieve the effect of loop play of the pictures in the picture sequence.

The preset play order is used to identify a play order of pictures in the picture sequence. Picture loop play can be implemented based on the preset play order.

In actual application, if the first picture is the starting picture in the picture sequence, before play of the target music starts, the synchronization time sequence corresponding to the target music is pre-loaded to a client. When play of the target music starts, a start play time of the target music (for example, 00:00) is used as the current play time point of the target music, and the first synchronization time that is closest to the current play time point of the target music and that is in the synchronization time sequence corresponding to the target music is used as the target synchronization time, so that the first picture can be synchronized played based on the current play time point of the target music and the target synchronization time.

In the media content display method provided in this embodiment of the present disclosure, first, in response to a play trigger operation for a target media content set, target music in the target media content set is played, and a first picture in a picture sequence in the target media content set is displayed, where the picture sequence includes a plurality of pictures with a preset play order. A current play time point of the target music is obtained in response to determining that display of the first picture ends. A synchronization time corresponding to the current play time point is determined from a synchronization time sequence corresponding to the target music as a target synchronization time. And a second picture is controlled, based on the current play time point of the target music and the target synchronization time, to be displayed during playing the target music, where the second picture is a next picture adjacent to the first picture in the picture sequence. In view of this, in this embodiment of the present disclosure, based on the synchronization time sequence corresponding to the target music, pictures are played based on beat synchronization points, so that display forms of media content are enriched, thereby improving display effect.

In actual application, during displaying the first picture, the first picture may also be controlled, by triggering a preset picture switching operation by a user, to end being displayed. To be specific, in the process of displaying the first picture, the first picture may be controlled, based on the preset picture switching operation triggered for the first picture, to end being displayed.

In a possible implementation, the current play time point of the target music is obtained in response to receiving the preset picture switching operation for the first picture. Specifically, in response to receiving the preset picture switching operation for the first picture, the current play time point of the target music corresponding to the preset picture switching operation for the first picture is obtained, the synchronization time corresponding to the current play time point is determined from the synchronization time sequence corresponding to the target music as the target synchronization time, and then the second picture is controlled to be displayed in the process of playing the target music based on the current play time point of the target music and the target synchronization time.

The preset picture switching operation is a preset picture switching manner, for example, sliding leftward or sliding rightward. The second picture is a next picture adjacent to the first picture in the picture sequence.

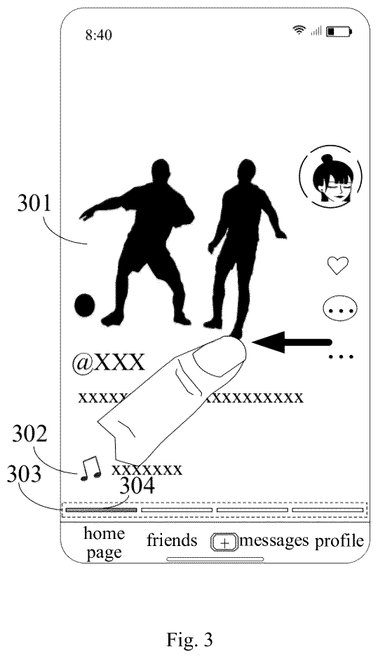

To understand the media content display method provided in this embodiment of the present disclosure more clearly, FIG. 3 is a schematic diagram of a picture display page according to an embodiment of the present disclosure. The picture display page displays a first picture 301, target music 302, and a play progress bar 303 corresponding to the picture sequence. The play progress bar 303 displays a play progress node corresponding to each picture in the picture sequence. For example, the progress node corresponding to the first picture 301 is a play progress node 304.

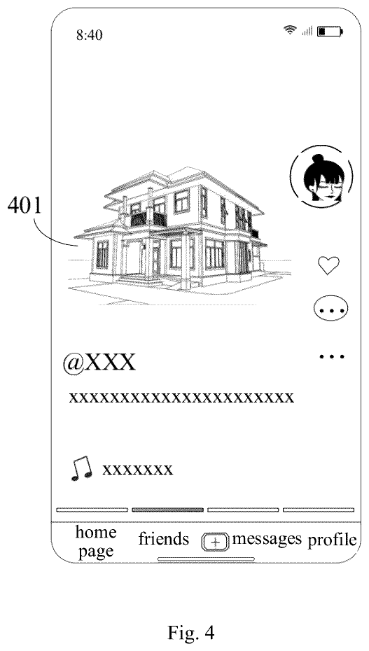

Specifically, in a process in which the user watches a video stream, a picture and text content display mode shown in FIG. 3 may be displayed. The target music 302 is played in the mode. In a process in which the target music 302 is played, the first picture 301 in the picture sequence is displayed. The user may perform a leftward-sliding operation on any position of the picture display page, to switch to the adjacent next picture, namely, the picture display page shown in FIG. 4. The picture display page shown in FIG. 4 displays the next picture (the second picture 401) adjacent to the first picture 301.

When the leftward-sliding operation of the user on any position of the picture display page is received, the current play time point of the target music 302 is obtained, then the synchronization time corresponding to the current play time point is determined from the synchronization time sequence corresponding to the target music 302 as the target synchronization time, and the second picture 401 is controlled, based on the current play time point of the target music 302 and the target synchronization time, to be displayed in the process of playing the target music 302.

In this embodiment provided in the present disclosure, the first picture may be controlled, through the preset picture switching operation triggered by the user, to end being displayed, and the second picture is controlled, based on the current play time point of the target music and the target synchronization time, to be displayed in the process of playing the target music, so as to enrich display forms of pictures, thereby improving the display effect.

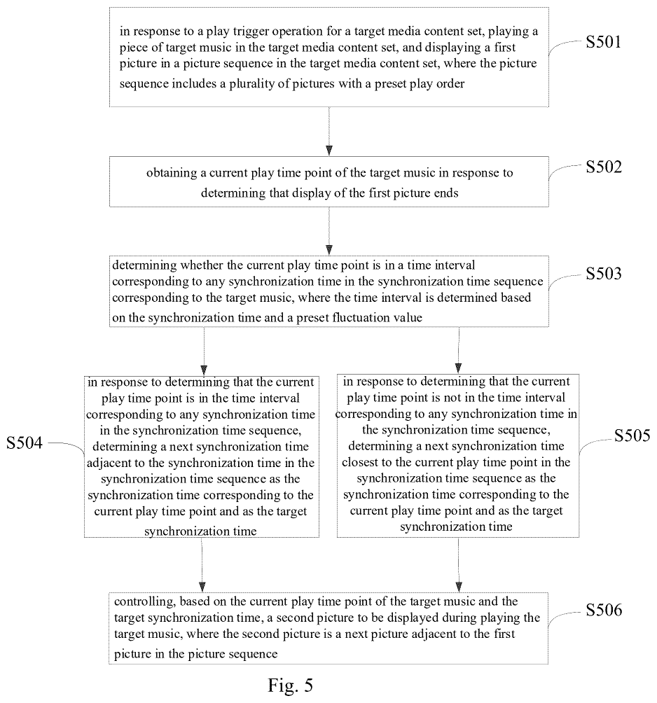

To alleviate the phenomenon that a particular picture flashes away in the process in which the user watches picture and text content, and to prevent the phenomenon from affecting the display effect, based on the content of the foregoing embodiment, an embodiment of the present disclosure further provides another media content display method. FIG. 5 is a flowchart of another media content display method according to this embodiment of the present disclosure. The method includes:
S501: in response to a play trigger operation for a target media content set, playing a piece of target music in the target media content set, and displaying a first picture in a picture sequence in the target media content set.

The picture sequence includes a plurality of pictures with a preset play order.
S502: obtaining a current play time point of the target music in response to determining that display of the first picture ends.

It should be noted that, steps S501 and S502 are the same as steps S101 and S102. For details, refer to the descriptions of steps S101 and S102. Details are not described herein in the present disclosure again.
S503: determining whether the current play time point is in a time interval corresponding to any synchronization time in the synchronization time sequence corresponding to the target music.

The time interval is determined based on the synchronization time and a preset fluctuation value.

Any synchronization time in the synchronization time sequence corresponding to the target music may be provided with a corresponding time interval. Specifically, the time interval is determined based on the synchronization time and a preset fluctuation value. The preset fluctuation value may be set based on a requirement.

For example, the preset fluctuation value is 0.01 second. In an optional implementation, a time interval corresponding to any synchronization time in the synchronization time sequence corresponding to the target music may be a time range of the synchronization time±0.01 second. For example, if the synchronization time is the 2.0^{th} second, the corresponding time interval is (the 1.99^{th} second to the 2.01^{st} second). In another optional implementation, a time interval corresponding to any synchronization time in the synchronization time sequence corresponding to the target music may be a time range of the synchronization time—0.01 second. For example, if the synchronization time is 2.0^{th} second, the corresponding time interval is (the 1.99^{th} second to the 2^{nd} second).

In an optional implementation, after the current play time point of the target music is obtained, it is determined whether the current play time point is in a time interval corresponding to any synchronization time in the synchronization time sequence corresponding to the target music.
S504: in response to determining that the current play time point is in the time interval corresponding to any synchronization time in the synchronization time sequence, determining a next synchronization time adjacent to the synchronization time in the synchronization time sequence as the synchronization time corresponding to the current play time point and as the target synchronization time.

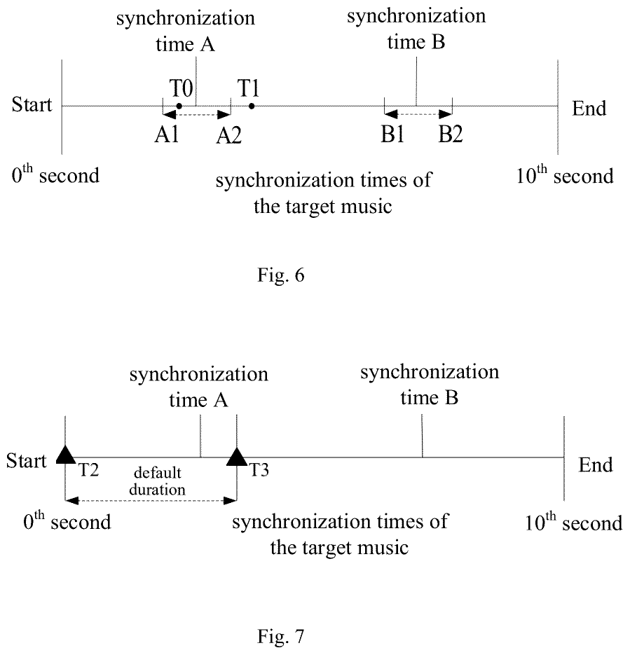

In this embodiment of the present disclosure, taking the position of the current play time point T0 shown in FIG. 6 as an example, it is determined that the current play time point is in the time interval corresponding to any synchronization time in the synchronization time sequence. A1-A2 represents a time interval corresponding to the synchronization time A, and B1-B2 represents a time interval corresponding to the synchronization time B. The current play time point T0 is in the time interval (A1-A2) corresponding to the synchronization time A. Because a time interval between the current play time point T0 and the synchronization time A is short, if the time interval is used as play duration of a particular picture, there will be a display effect of the picture flashing away, which will affect the display effect. Therefore, the next synchronization time B adjacent to the synchronization time A corresponding to the current play time point T0 may be used as the target synchronization time corresponding to the current play time point T0.

In this embodiment of the present disclosure, the current play time point of the target music is compared with the time interval corresponding to each synchronization time in the synchronization time sequence corresponding to the target music. When it is determined that the current play time point is in the time interval corresponding to any synchronization time in the synchronization time sequence, the next synchronization time adjacent to the synchronization time in the synchronization time sequence is determined as the synchronization time corresponding to the current play time point, to avoid the display phenomenon that a particular picture flashes away once the current play time point is located in a time interval close to a particular synchronization time in a process in which the user watches the picture and text content. As shown in FIG. 6, if the current play time point of the target music is the point T0, and if no time interval is set for any synchronization time in the synchronization time sequence corresponding to the target music, when the second picture is controlled, based on the current play time point T0 of the target music and the target synchronization time A, to be displayed in the process of playing the target music, the phenomenon that the second picture flashes away due to a short time interval between T0 and the point A is caused. A time interval is set for any synchronization time in the synchronization time sequence corresponding to the target music, so that the second picture is displayed based on the current play time point T0 and the target synchronization time B of the target music, to avoid the phenomenon that pictures flash away during picture display.
S505: in response to determining that the current play time point is not in the time interval corresponding to any synchronization time in the synchronization time sequence, determining a next synchronization time closest to the current play time point in the synchronization time sequence as the synchronization time corresponding to the current play time point and as the target synchronization time.

In this embodiment of the present disclosure, taking the position of the current play time point T1 shown in FIG. 6 as an example, it is determined that the current play time point is not in the time interval corresponding to any synchronization time in the synchronization time sequence, namely, the current play time point T1 is not in the time interval corresponding to any synchronization time in the synchronization time sequence. Because a time interval between the position of the current play time point T1 and the synchronization time B is sufficiently long, the next synchronization time B closest to the current play time point T1 may be used as the target synchronization time corresponding to the current play time point T1.
S506: controlling, based on the current play time point of the target music and the target synchronization time, a second picture to be displayed during playing the target music.

The second picture is a next picture adjacent to the first picture in the picture sequence.

It should be noted that, an execution process of step S506 is the same as that of step S104. For details, refer to the descriptions of step S104. Details are not described herein in the present disclosure again.

In the media content display method provided in this embodiment of the present disclosure, in response to the play trigger operation for the target media content set, the target music in the target media content set is played, and the first picture in the picture sequence in the target media content set is displayed, where the picture sequence includes the plurality of pictures with the preset play order. The current play time point of the target music is obtained in response to determining that display of the first picture ends. It is determined whether the current play time point is in the time interval corresponding to any synchronization time in the synchronization time sequence corresponding to the target music. If it is determined that the current play time point is in the time interval corresponding to any synchronization time in the synchronization time sequence, the next synchronization time adjacent to the synchronization time in the synchronization time sequence is determined as the synchronization time corresponding to the current play time point and as the target synchronization time; and/or, if it is determined that the current play time point is not in the time interval corresponding to any synchronization time in the synchronization time sequence, the next synchronization time closest to the current play time point in the synchronization time sequence is determined as the synchronization time corresponding to the current play time point and as the target synchronization time. The second picture is controlled, based on the current play time point of the target music and the target synchronization time, to be displayed in the process of playing the target music.

In view of this, in this embodiment of the present disclosure, the current play time point of the target music is compared with the time interval corresponding to any synchronization time in the synchronization time sequence corresponding to the target music. When it is determined that the current play time point is in the time interval corresponding to any synchronization time in the synchronization time sequence, the next synchronization time adjacent to the synchronization time in the synchronization time sequence is determined as the synchronization time corresponding to the current play time point; and/or, when it is determined that the current play time point is not in the time interval corresponding to any synchronization time in the synchronization time sequence, the next synchronization time closest to the current play time point in the synchronization time sequence is determined as the synchronization time corresponding to the current play time point. This avoids the phenomenon that a particular picture flashes away in the process in which the user watches the picture and text content, enriches display forms of media content, and improves the display effect.

In addition, in actual application, due to reasons such as an excessively large synchronization time sequence corresponding to the target music, loading of the synchronization time sequence is not completed in the process of displaying the picture sequence, affecting the display effect. Therefore, in this embodiment of the present disclosure, the synchronization time sequence corresponding to the target music may be detected in the process of playing the target music, and whether loading of the synchronization time sequence is completed is specifically detected. In an optional implementation, in response to the play trigger operation for the target media content set, the target music in the target media content set is played, and whether the synchronization time sequence corresponding to the target music exists in the target media content set is detected. If the synchronization time sequence corresponding to the target music is not detected, the first picture in the picture sequence in the target media content set is displayed based on default play duration, and after loading of the synchronization time sequence corresponding to the target music succeeds, the subsequent pictures in the picture sequence continue to be displayed based on the synchronization time sequence corresponding to the target music.

The default play duration may be preset, namely, play duration for each picture is the default play duration.

To facilitate understanding of this embodiment of the present disclosure, FIG. 7 is a schematic diagram of still another synchronization time of target music according to an embodiment of the present disclosure. FIG. 7 shows start and end times of the target music and the corresponding synchronization time. Assuming that the first picture is the starting picture in the picture sequence, and if no synchronization time sequence corresponding to target music is detected in the process of playing the target music, the first picture is displayed based on default duration (the T2-T3 time interval shown in FIG. 7). To be specific, the first picture starts to be displayed at T2, and ends to be displayed at T3. If it is detected, after display of the first picture ends, that loading of the synchronization time sequence corresponding to the target music is successful, the current play time point T3 of the target music is obtained, and the next picture adjacent to the first picture is displayed based on T3-B, and then the synchronization time B corresponding to the current play time point T3 is determined from the synchronization time sequence corresponding to the target music as the target synchronization time, so that the second picture is displayed in the T3-B time interval.

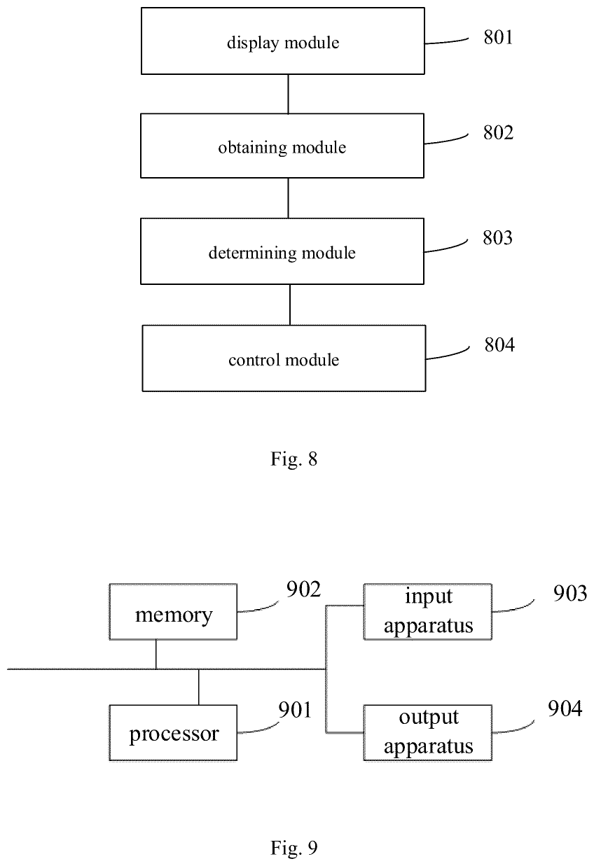

Based on the foregoing method embodiment, the present disclosure further provides a media content display apparatus. FIG. 8 is a schematic structural diagram of a media content display apparatus according to an embodiment of the present disclosure. The apparatus includes:
a display module 801, configured to: in response to a play trigger operation for a target media content set, play a piece of target music in the target media content set, and display a first picture in a picture sequence in the target media content set, where the picture sequence includes a plurality of pictures with a preset play order;
an obtaining module 802, configured to obtain a current play time point of the target music in response to determining that display of the first picture ends;
a determining module 803, configured to determine, from a synchronization time sequence corresponding to the target music, a synchronization time corresponding to the current play time point as a target synchronization time; and
a control module 804, configured to control, based on the current play time point of the target music and the target synchronization time, a second picture to be displayed during playing the target music, where the second picture is a next picture adjacent to the first picture in the picture sequence.

In an optional implementation, the obtaining module is specifically configured to: obtain the current play time point of the target music in response to receiving a preset picture switching operation for the first picture.

In an optional implementation, the determining module includes:
a matching submodule, configured to match the current play time point with the synchronization time sequence corresponding to the target music; and
a first determining submodule, configured to determine, based on a result of matching between the current play time point and the synchronization time sequence, the synchronization time corresponding to the current play time point as the target synchronization time.

In an optional implementation, the matching submodule is specifically configured to: determine whether the current play time point is in a time interval corresponding to any synchronization time in the synchronization time sequence corresponding to the target music, where the time interval is determined based on the synchronization time and a preset fluctuation value; and

Correspondingly, the first determining submodule includes:
a second determining submodule, configured to: in response to determining that the current play time point is in the time interval corresponding to any synchronization time in the synchronization time sequence, determine a next synchronization time adjacent to the synchronization time in the synchronization time sequence as the synchronization time corresponding to the current play time point and as the target synchronization time; and/or
a third determining submodule, configured to: in response to determining that the current play time point is not in the time interval corresponding to any synchronization time in the synchronization time sequence, determine a next synchronization time closest to the current play time point in the synchronization time sequence as the synchronization time corresponding to the current play time point and as the target synchronization time.

In an optional implementation, the control module is specifically configured to: control the second picture to start to be displayed at the current play time point of the target music, and control the second picture to end being displayed when the target music is played to the target synchronization time.

In an optional implementation, the control module includes:
a fourth determining submodule, configured to determine play duration of the second picture based on the current play time point of the target music and the target synchronization time; and
a control submodule, configured to: control the second picture to start to be displayed at the current play time point of the target music, and start timing, and control the second picture to end being displayed when timing duration reaches the play duration.

In an optional implementation, the first picture is the last picture in the picture sequence, and the second picture is the starting picture in the picture sequence.

In an optional implementation, the display module includes:
a play submodule, configured to: in response to the play trigger operation for the target media content set, play the target music in the target media content set, and detect whether the synchronization time sequence corresponding to the target music exists in the target media content set; and
a display submodule, configured to: in response to not detecting the synchronization time sequence corresponding to the target music, display the first picture in the picture sequence in the target media content set based on default play duration; and

Correspondingly, the obtaining module is specifically configured to: in response to determining that display of the first picture ends, when the synchronization time sequence corresponding to the target music is detected, obtain the current play time point of the target music.

In an optional implementation, the apparatus further includes:
a processing module, configured to process abnormal synchronization times in the synchronization time sequence corresponding to the target music, where the abnormal synchronization times includes adjacent synchronization times with interval duration greater than a preset first duration threshold and/or adjacent synchronization times with interval duration less than a preset second duration threshold.

In an optional implementation, the synchronization time sequence includes a synchronization time determined based on a rhythm change feature and/or a lyric feature of the target music.

In the media content display apparatus provided in this embodiment of the present disclosure, first, in response to a play trigger operation for a target media content set, target music in the target media content set is played, and a first picture in a picture sequence in the target media content set is displayed, where the picture sequence includes a plurality of pictures with a preset play order. A current play time point of the target music is obtained in response to determining that display of the first picture ends. A synchronization time corresponding to the current play time point is determined from a synchronization time sequence corresponding to the target music as a target synchronization time. A second picture is controlled, based on the current play time point of the target music and the target synchronization time, to be displayed during playing the target music, where the second picture is a next picture adjacent to the first picture in the picture sequence. In view of this, in this embodiment of the present disclosure, based on the synchronization time sequence corresponding to the target music, pictures are played based on beat synchronization points, so that display forms of media content are enriched, thereby improving display effect.

In addition to the foregoing method and apparatus, an embodiment of the present disclosure further provides a computer-readable storage medium. The computer-readable storage medium stores instructions. When the instructions are run on a terminal device, the terminal device is enabled to perform the foregoing media content display method in embodiments of the present disclosure.

An embodiment of the present disclosure further provides a computer program product, including a computer program/instruction, where when the computer program/instruction is executed by a processor, the media content display method in embodiments of the present disclosure is implemented.

In addition, an embodiment of the present disclosure further provides a media content display device. With reference to FIG. 9, the media content display device may include: a processor 901, a memory 902, an input apparatus 903, and an output apparatus 904. There may be one or more processors 901 in the element drawing device. For example, there is one processor 901 in FIG. 9. In some embodiments of the present disclosure, the processor 901, the memory 902, the input apparatus 903, and the output apparatus 904 may be connected by using a bus or in other manners, with an example of bus connection shown in FIG. 9.

The memory 902 may be configured to store software programs and modules. The processor 901 executes various functional applications and data processing of the media content display device by running the software programs and the modules stored in the memory 902. The memory 902 may mainly include a program storage area and a data storage area, where the program storage area may store an operating system, an application required by at least one function, and the like. In addition, the memory 902 may include a high-speed random access memory, and may further include a non-volatile memory such as at least one magnetic disk storage component, a flash memory, or another volatile solid-state storage component. The input apparatus 903 may be configured to: receive input numeric or character information, and generate a signal input related to user settings and function control of the element drawing device.

Specifically, in this embodiment, the processor 901 loads, according to the following instruction, executable files corresponding to processes of one or more applications, into the memory 902, and the processor 901 runs the applications stored in the memory 902, to implement various functions of the media content display device.

It should be noted that, in this specification, relational terms such as “first” and “second” are used only to distinguish one entity or operation from another, and do not necessarily require or imply the existence of any such actual relationship or order between those entities or operations. In addition, the terms “include”, “comprise” or any other variant thereof are intended to cover non-exclusive inclusion, so that a process, method, article or device including a series of elements includes not only those elements, but also other elements that are not expressly listed, or that are inherent to such a process, method, article or device. Without further limitation, an element defined by the statement “includes a . . . ” does not exclude the existence of another same element in the process, method, article or device in which the element is included.

The foregoing are merely specific implementations of the present disclosure to enable a person skilled in the art to understand or implement the present disclosure. Various modifications to these embodiments will be apparent to a person skilled in the art, and the general principles defined herein can be realized in other embodiments without departing from the spirit or scope of the present disclosure Therefore, the present disclosure will not be limited to these embodiments herein, but will be subject to the broadest scope consistent with the principles and novel features disclosed herein.

1. A media content display method, comprising:
in response to a play trigger operation for a target media content set, playing a piece of target music in the target media content set, and displaying a first picture in a picture sequence in the target media content set, wherein the picture sequence comprises a plurality of pictures with a preset play order;
obtaining a current time point of the target music in response to determining that display of the first picture ends;
determining, from a synchronization time sequence corresponding to the target music, a synchronization time corresponding to the current time point as a target synchronization time; and
displaying, based on the current time point of the target music and the target synchronization time, a second picture during playing the target music, wherein the second picture is a next picture adjacent to the first picture in the picture sequence.

2. The method according to claim 1, wherein the obtaining a current time point of the target music in response to determining that display of the first picture ends comprises:
obtaining the current time point of the target music in response to receiving a preset picture switching operation for the first picture.

3. The method according to claim 1, wherein the determining, from a synchronization time sequence corresponding to the target music, a synchronization time corresponding to the current time point as a target synchronization time comprises:
matching the current time point with the synchronization time sequence corresponding to the target music; and
determining, based on a result of matching between the current time point and the synchronization time sequence, the synchronization time corresponding to the current time point as the target synchronization time.

4. The method according to claim 3, wherein the matching the current time point with the synchronization time sequence corresponding to the target music comprises:
determining whether the current time point is in a time interval corresponding to any synchronization time in the synchronization time sequence corresponding to the target music, wherein the time interval is determined based on the synchronization time and a preset fluctuation value; and
correspondingly, the determining, based on a result of matching between the current time point and the synchronization time sequence, the synchronization time corresponding to the current time point as the target synchronization time comprises:
in response to determining that the current time point is in the time interval corresponding to any synchronization time in the synchronization time sequence, determining a next synchronization time adjacent to the synchronization time in the synchronization time sequence as the synchronization time corresponding to the current time point and as the target synchronization time; and/or in response to determining that the current time point is not in the time interval corresponding to any synchronization time in the synchronization time sequence, determining a next synchronization time closest to the current time point in the synchronization time sequence as the synchronization time corresponding to the current time point and as the target synchronization time.

5. The method according to claim 1, wherein the displaying, based on the current time point of the target music and the target synchronization time, a second picture during playing the target music comprises:
start displaying the second picture at the current time point play of the target music, and stop displaying the second picture when the target music is played to the target synchronization time.

6. The method according to claim 1, wherein the displaying, based on the current time point of the target music and the target synchronization time, a second picture during playing the target music comprises:
determining play duration of the second picture based on the current time point of the target music and the target synchronization time; and
start displaying the second picture at the current time point of the target music, and starting timing, and stop displaying the second picture when timing duration reaches the play duration.

7. The method according to claim 1, wherein the first picture is a last picture in the picture sequence, and the second picture is a starting picture in the picture sequence.

8. The method according to claim 1, wherein the in response to a play trigger operation for a target media content set, playing a piece of target music in the target media content set, and displaying a first picture in a picture sequence in the target media content set comprises:
in response to the play trigger operation for the target media content set, playing the target music in the target media content set, and detecting whether the synchronization time sequence corresponding to the target music exists in the target media content set; and
in response to not detecting the synchronization time sequence corresponding to the target music, displaying the first picture in the picture sequence in the target media content set based on default play duration; and
correspondingly, the obtaining a current time point of the target music in response to determining that display of the first picture ends comprises:
in response to determining that display of the first picture ends, when the synchronization time sequence corresponding to the target music is detected, obtaining the current time point of the target music.

9. The method according to claim 1, wherein before the determining, from a synchronization time sequence corresponding to the target music, a synchronization time corresponding to the current time point as a target synchronization time, the method further comprises:
processing abnormal synchronization times in the synchronization time sequence corresponding to the target music, wherein the abnormal synchronization times comprises adjacent synchronization times with interval duration greater than a preset first duration threshold and/or adjacent synchronization times with interval duration less than a preset second duration threshold.

10. The method according to claim 1, wherein the synchronization time sequence comprises a synchronization time determined based on a rhythm change feature and/or a lyric feature of the target music.

11. (canceled)

12. A computer-readable storage medium storing instructions, wherein when the instructions are run on a terminal device, the terminal device is enabled to implement a media content display method, wherein the media content display method comprises:
in response to a play trigger operation for a target media content set, playing a piece of target music in the target media content set, and displaying a first picture in a picture sequence in the target media content set, wherein the picture sequence comprises a plurality of pictures with a preset play order;
obtaining a current time point of the target music in response to determining that display of the first picture ends;
determining, from a synchronization time sequence corresponding to the target music, a synchronization time corresponding to the current time point as a target synchronization time; and
displaying, based on the current time point of the target music and the target synchronization time, a second picture during playing the target music, wherein the second picture is a next picture adjacent to the first picture in the picture sequence.

13. A media content display device, comprising a memory, a processor, and a computer program that is stored in the memory and that can be run on the processor, wherein when the processor executes the computer program, a media content display method is implemented, wherein the media content display method comprises:
in response to a play trigger operation for a target media content set, playing a piece of target music in the target media content set, and displaying a first picture in a picture sequence in the target media content set, wherein the picture sequence comprises a plurality of pictures with a preset play order;
obtaining a current time point of the target music in response to determining that display of the first picture ends;
determining, from a synchronization time sequence corresponding to the target music, a synchronization time corresponding to the current time point as a target synchronization time; and
displaying, based on the current time point of the target music and the target synchronization time, a second picture during playing the target music, wherein the second picture is a next picture adjacent to the first picture in the picture sequence.

14. (canceled)

15. The media content display device according to claim 13, wherein the obtaining a current time point of the target music in response to determining that display of the first picture ends comprises:
obtaining the current time point of the target music in response to receiving a preset picture switching operation for the first picture.

16. The media content display device according to claim 13, wherein the determining, from a synchronization time sequence corresponding to the target music, a synchronization time corresponding to the current time point as a target synchronization time comprises:
matching the current time point with the synchronization time sequence corresponding to the target music; and
determining, based on a result of matching between the current time point and the synchronization time sequence, the synchronization time corresponding to the current time point as the target synchronization time.

17. The media content display device according to claim 16, wherein the matching the current time point with the synchronization time sequence corresponding to the target music comprises:
determining whether the current time point is in a time interval corresponding to any synchronization time in the synchronization time sequence corresponding to the target music, wherein the time interval is determined based on the synchronization time and a preset fluctuation value; and
correspondingly, the determining, based on a result of matching between the current time point and the synchronization time sequence, the synchronization time corresponding to the current time point as the target synchronization time comprises:
in response to determining that the current time point is in the time interval corresponding to any synchronization time in the synchronization time sequence, determining a next synchronization time adjacent to the synchronization time in the synchronization time sequence as the synchronization time corresponding to the current time point and as the target synchronization time; and/or
in response to determining that the current time point is not in the time interval corresponding to any synchronization time in the synchronization time sequence, determining a next synchronization time closest to the current time point in the synchronization time sequence as the synchronization time corresponding to the current time point and as the target synchronization time.

18. The media content display device according to claim 13, wherein the displaying, based on the current time point of the target music and the target synchronization time, a second picture during playing the target music comprises:
start displaying the second picture at the current time point of the target music, and stop displaying the second picture when the target music is played to the target synchronization time.

19. The media content display device according to claim 13, wherein the displaying, based on the current time point of the target music and the target synchronization time, a second picture during playing the target music comprises:
determining play duration of the second picture based on the current time point of the target music and the target synchronization time; and
start displaying the second picture at the current time point of the target music, and starting timing, and stop displaying the second picture when timing duration reaches the play duration.

20. The media content display device according to claim 13, wherein the first picture is a last picture in the picture sequence, and the second picture is a starting picture in the picture sequence.

21. The media content display device according to claim 13, wherein the in response to a play trigger operation for a target media content set, playing a piece of target music in the target media content set, and displaying a first picture in a picture sequence in the target media content set comprises:
in response to the play trigger operation for the target media content set, playing the target music in the target media content set, and detecting whether the synchronization time sequence corresponding to the target music exists in the target media content set; and
in response to not detecting the synchronization time sequence corresponding to the target music, displaying the first picture in the picture sequence in the target media content set based on default play duration; and
correspondingly, the obtaining a current time point of the target music in response to determining that display of the first picture ends comprises:
in response to determining that display of the first picture ends, when the synchronization time sequence corresponding to the target music is detected, obtaining the current time point of the target music.

22. The media content display device according to claim 13, wherein before the determining, from a synchronization time sequence corresponding to the target music, a synchronization time corresponding to the current time point as a target synchronization time, the method further comprises:
processing abnormal synchronization times in the synchronization time sequence corresponding to the target music, wherein the abnormal synchronization times comprises adjacent synchronization times with interval duration greater than a preset first duration threshold and/or adjacent synchronization times with interval duration less than a preset second duration threshold.
